(19) United States
(12) Patent Application Publication
(10) Pub. No.: US 2005/0020301 A1
(43) Pub. Date: Jan. 27, 2005

(54) Method for managing a schedule in a mobile communication terminal

(75) Inventor: Woo-Jin Lee, Seoul (KR)

Correspondence Address: Paul J. Farrell, Esq.;DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 10/653,492

(22) Filed: Sep. 2, 2003

(30) Foreign Application Priority Data
Sep. 12, 2002 (KR) 2002-55346

(51) Int. Cl. H04M 1/00

(52) U.S. Cl. 455/556.1; 455/566

(57) ABSTRACT

A method for managing a schedule using a mobile communication terminal, and a schedule management method based on contents of a schedule. A method for managing a schedule according to a level of importance according to a level of in a mobile communication terminal includes the steps of: a) determining whether a present time matches an alarm time for schedule notification; b) if the present time matches the alarm time for schedule notification, displaying contents of the schedule; c) determining whether a scheduled time of a schedule item contained in the schedule has passed; d) if the scheduled time of the schedule item has passed, determining importance of the schedule item; and e) if the schedule item is of low-level importance, deleting contents of the schedule item.

### PRIORITY

This application claims priority to an application entitled “METHOD FOR MANAGING SCHEDULE IN MOBILE COMMUNICATION TERMINAL”, filed in the Korean Industrial Property Office on Sep. 12, 2002 and assigned Serial No. 2002-55346, the contents of which are hereby incorporated by reference.

### BACKGROUND OF THE INVENTION

1. Field of the Invention

The present invention relates to a method for managing a schedule using a mobile communication terminal, and more particularly to a schedule management method based on contents of a schedule.

2. Description of the Related Art

Because a mobile communication terminal carried by a user can notify the user of information indicating a correct time, many users employ mobile communication terminals for use in schedule management. However, a schedule management function provided by a conventional communication terminal is based on a schedule time. For example, the conventional mobile communication terminal provides schedule management and registration information through a calendar screen on the display of the terminal, and provides an alarm at a predetermined alarm time for schedule notification (e.g., thirty minutes ahead of schedule, five minutes ahead of schedule, a scheduled time, etc.). The conventional schedule management function is based on the schedule time, and provides an indication of items of the schedule only at scheduled times. In addition, because preset schedule contents are not automatically deleted, even though a predetermined period of time passes, the user must directly delete the schedule contents.

Accordingly, when conventional schedule management is performed, there are problems in that the user cannot identify which schedule items of a schedule are more important, and unnecessary schedule contents must be manually deleted.

### SUMMARY OF THE INVENTION

Therefore, the present invention has been made in view of the above problems, and it is an object of the present invention to provide a method for managing a schedule in a mobile communication terminal, the method being capable of managing the schedule based on levels of importance.

In accordance with an aspect of the present invention, the above and other objects can be accomplished by the provision of a method for managing a schedule on the basis of importance in a mobile communication terminal, comprising the steps of: a) determining whether a present time matches an alarm time for schedule notification; b) if the present time matches the alarm time for schedule notification, displaying contents of the schedule; c) determining whether a scheduled time of an item contained in the schedule has passed; d) if the scheduled time of the schedule item has passed, determining a level of importance of the schedule item; and e) if the schedule item is of low level importance, deleting the contents of the schedule item.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a configuration of a mobile communication terminal to which the present invention is applied;

FIGS. 2A-C are views illustrating screens displayed on a display unit of the mobile communication terminal when a schedule is inputted in accordance with an embodiment of the present invention;

FIGS. 3A-3C are views illustrating screens displayed on the display unit of the mobile communication terminal when the schedule is inputted in accordance with another embodiment of the present invention;

FIGS. 4A-4B are views illustrating a schedule notification screen displayed on the display unit of the mobile communication terminal in accordance with an embodiment of the present invention;

FIG. 5 is a flow chart illustrating a schedule input procedure in accordance with an embodiment of the present invention;

FIG. 6 is a flow chart illustrating an operation of the mobile communication terminal at a start time of a schedule in accordance with an embodiment of the present invention; and

FIG. 7 is a flow chart illustrating a procedure of informing a user of a schedule in the mobile communication terminal at normal times in accordance with an embodiment of the present invention.

### DETAILED DESCRIPTION OF THE PREFERRED EMBODIMENTS

As described below, the present invention relates to schedule management through a mobile communication terminal, and more particularly to a schedule management method capable of managing a schedule based on the importance of scheduled items. To manage the schedule based on the importance of scheduled items, the schedule management method of the present invention is focused on contents-based schedule management rather than time-based schedule management.

Now, preferred embodiments of the present invention will be described in detail with reference to the annexed drawings. In the drawings, the same or similar elements are denoted by the same reference numerals even though they are depicted in different drawings. Further, in the following description of the present invention, a detailed description of known functions and configurations incorporated herein will be omitted to avoid making the subject matter of the present invention unclear.

As described above, embodiments of the present invention perform contents-based schedule management rather than time-based schedule management. To perform contents-based schedule management, the present invention provides for a determined time period, such as a one-day time period. The present invention provides for notifying a user of schedule contents several times during the determined time period. The number of times that the user is notified is based upon the level of importance of the schedule contents. For example, if the user inputs several important schedule items into the mobile communication terminal while riding a subway train in the morning, the mobile communication terminal notifies the user of each inputted schedule item a different number of times based on the level of importance of each item, thereby enabling the user to remember that day's important schedule items. Further, if the schedule based on the importance level is stored in the mobile communication terminal by the user, schedule items of low level importance are automatically deleted from the mobile communication terminal after a predetermined period of time, and schedule items of high level importance can be stored in the mobile communication terminal for an extended period of time, such as for one day. The schedule management method of the present invention can be performed on a daily basis. Of course, the schedule management of the present invention can be alternatively performed on a weekly, monthly or yearly basis in response to the user's selection. Although the embodiments described herein are described in reference to schedule management on a daily basis, it is understood that the scope of the present invention is not limited thereby.

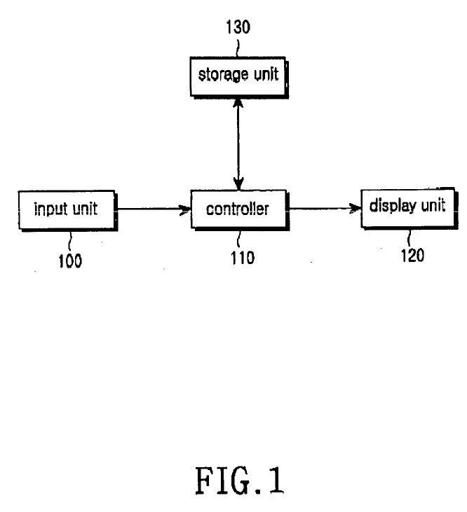

FIG. 1 is a view illustrating a configuration of a mobile communication terminal to which the present invention is applied.

As shown in FIG. 1, the mobile communication terminal suitable for use with an embodiment of the present invention comprises: an input unit 100 for receiving information of operating conditions after determining whether a schedule management function should be carried out in the mobile communication terminal; a display or output unit 120 for displaying or outputting information of set operating conditions to the user so that the user can identify the set operating conditions when the operating conditions such as a start time of the schedule management function, etc. are set; a storage unit 130 for storing the operating conditions and schedule contents inputted from the input unit 100; and a controller 110 for controlling the input unit 100, the output unit 120 and the storage unit 130 so that the schedule management function can be carried out. The input unit 100 can be implemented by, for example, a keypad, a stylus pen, a touch pad, a jog dial, or any input unit known to one of ordinary skill in the art. The display unit 120 can be implemented by, for example, an LCD (Liquid Crystal Display), or any display unit known to one of ordinary skill in the art The user can start the schedule management function through the input unit 100, and perform a schedule input procedure while viewing inputted schedule contents using display unit 120.

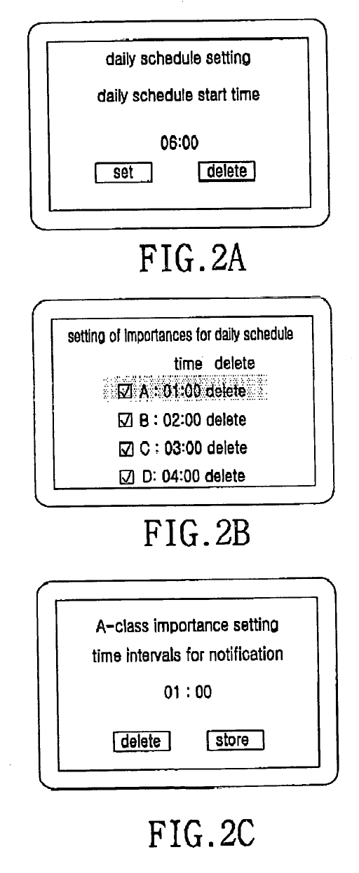

FIGS. 2A-2C are views illustrating exemplary screens displayed on a display unit of the mobile communication terminal when scheduled items are inputted in accordance with an embodiment of the present invention. Exemplary configuration screens include schedule start time, importance level indicators for schedule items, and time intervals between notifications. In FIG. 2A, a screen for setting a start time of a daily schedule management function is shown. In FIG. 2B, a screen for setting importance levels of daily schedule items contained in a daily schedule is shown, and in FIG. 2C, a screen for setting time intervals of notifications based on the importance levels of the daily schedule items is shown. As shown in FIGS. 2A-C, the start time setting screen of the schedule management function can be implemented similarly to an alarm setting screen. In FIG. 2B, screen 2b enables the user to set the operating conditions so that a schedule item of high-level (A-class) importance can be continuously stored in the mobile communication terminal after a scheduled time. Further, the user can arbitrarily decide and set importance levels if desired, such as mid-level (B-class or C-class) importance or low-level (D-class) importance. It is understood that the present invention is not limited to this embodiment. In FIG. 2C, screen 2c allows a user to set time intervals of notifications based on the importance levels of the daily schedule items.

For example, referring to FIG. 2B, A-class importance corresponds to a schedule item, about which the user is notified every hour and which is further stored after one day passes, B-class importance corresponds to a schedule item which is displayed at intervals of two hours and automatically deleted after one day passes, C-class importance corresponds to a schedule item, which is displayed at intervals of three hours, and D-class importance corresponds to a schedule item which is displayed at intervals of four hours. Referring to FIG. 2C, wherein a schedule item is of A-class importance in the screen 2C, the user is notified of the schedule item every hour. The user can arbitrarily set these conditions. The example of the level of importance setting function has been described to help in the understanding of the present invention, and the present invention is not limited to the example.

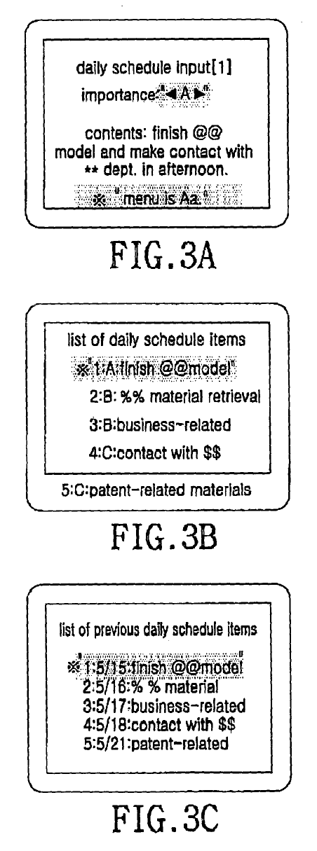

FIGS. 3A-3C are views illustrating screens displayed on the display unit of the mobile communication terminal when the schedule is inputted in accordance with another embodiment of the present invention.

In FIG. 3A, a screen displayed on the display unit 120 of the mobile communication terminal when a daily schedule is inputted is shown. The user can input the importance level and contents of each schedule item while viewing the screen. In FIG. 3B, a screen for displaying a list of daily schedule items is shown. Schedule contents contained in the list of the schedule items to be managed for one day are arranged and displayed on the basis of the level of importance of the schedule items. The user can identify all schedule items planned for the day and the importance level of the schedule items, thereby effectively managing the respective schedule items. In FIG. 3C, a screen for displaying a list of a previous schedule is shown. Through the list of the previous schedule items, the user can identify which event or task happened previously. In an embodiment of the present invention, only schedule items of A-class importance are stored in the list of the previous schedule items. The user can arbitrarily set previous schedule items to be stored in the list of the previous schedule items. At this time, the user can set the previous schedule items to be stored in the list of the previous schedule items while viewing screen 2b of FIG. 2B. The user can delete the schedule items stored in the mobile communication terminal and identify the stored schedule items until they are deleted because of insufficient storage space.

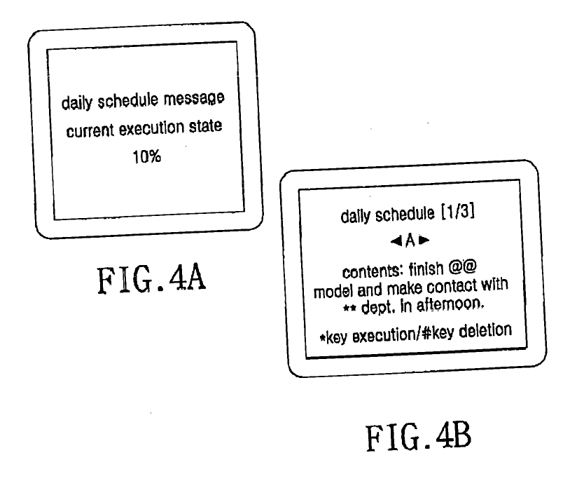

FIGS. 4A-4B are views illustrating a daily schedule notification screen displayed on the display unit of the mobile communication terminal in accordance with an embodiment of the present invention.

In FIG. 4A, a screen for displaying a current execution state of a daily schedule is shown. Screen 4a displays a percentage as the current execution state of the daily schedule. In FIG. 4B, a screen for displaying a daily schedule at normal times is shown. The screen displayed at normal times provides contents of the schedule items along with an alarm at preset time intervals based on the importance level. Where the number of the schedule items to be displayed is more than one schedule item, the contents of more than one schedule item are alternately displayed. The user can identify detailed contents of the schedule item through the screen by inputting a predetermined key. In one embodiment of the present invention, a confirmation key is used as the predetermined key. On the other hand, where some schedule item has already been executed or the user desires to delete some schedule item, the user designates the schedule item as an executed schedule item or a deletion item so that the schedule item is no longer displayed. The executed schedule item is not displayed next, but is stored for one day. As soon as a schedule item is designated as the deletion item, the contents of a corresponding schedule item except for a schedule item of A-class importance are immediately deleted from the mobile communication terminal. If a start time of a daily schedule passes, other schedule items except for schedule items of A-class importance are deleted. The schedule items of A-class importance are stored for an entire management schedule until the user manually deletes them so that the user can remember previous events and tasks.

Hereinafter, an operation of the embodiment of the present invention will be described with reference to drawings.

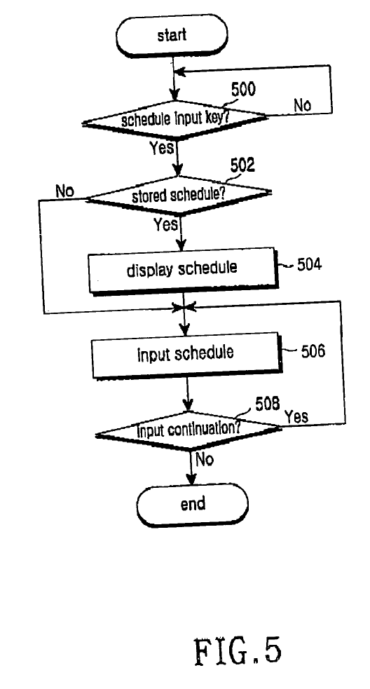

FIG. 5 is a flow chart illustrating a schedule input procedure in accordance with an embodiment of the present invention.

If a daily schedule has been already set when the schedule input procedure is performed, the previously set daily schedule is provided on a screen for displaying a list of daily schedule items. Otherwise, the list screen is not displayed and an input screen is immediately provided. If selection of a schedule input key is recognized at step 500, the mobile communication terminal starts the schedule input procedure in accordance with the embodiment of the present invention. The mobile communication terminal determines, at step 502, whether a preset schedule exists. If the preset schedule exists, the mobile communication terminal displays the schedule through the display unit 120 at step 504. For example, the schedule can be displayed in the form of a list of daily schedule items shown in screen 3b of FIG. 3B. After the list of daily schedule items is displayed at the above step 504, the schedule is inputted at step 506. On the other hand, if the preset schedule does not exist, the mobile communication terminal immediately proceeds to the above step 506. It is determined at step 508 if the schedule input is complete. If the schedule input is not completed, the above step 506 is repeated. On the other hand, if the schedule input is completed, the schedule input procedure is terminated.

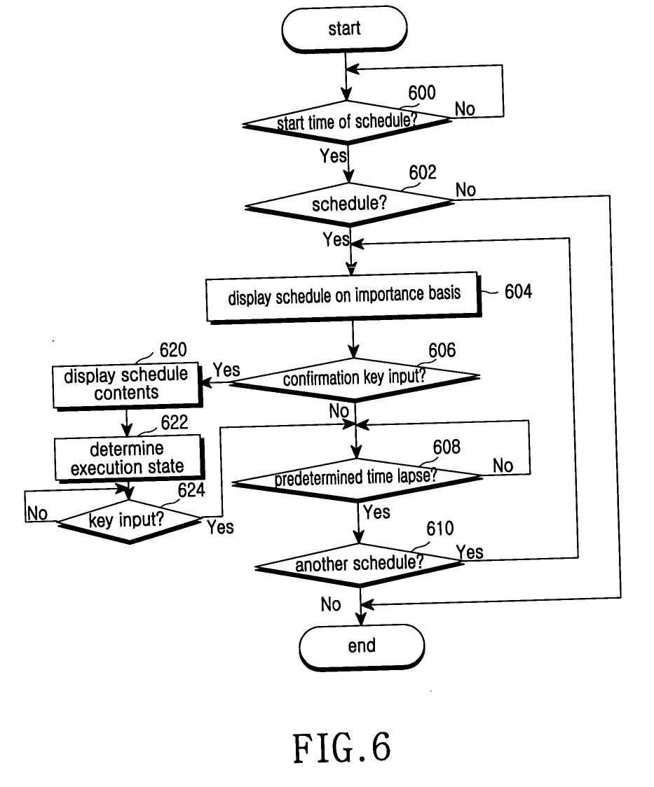

FIG. 6 is a flow chart illustrating an operation of the mobile communication terminal at a start time of a schedule in accordance with an embodiment of the present invention.

As shown in FIG. 6, the mobile communication terminal determines, at step 600, whether a present time matches a start time of a schedule. If the present time matches the start time of the schedule, the mobile communication terminal determines, at step 602, whether a preset schedule exists. If the preset schedule exists, the mobile communication terminal displays schedule items of the preset schedule based on the level of importance at step 604. Now, the schedule display will be described in detail. The mobile communication terminal determines, at step 606, whether a confirmation key is inputted and then proceeds to step 620. If the confirmation key is inputted, the mobile communication terminal displays detailed contents of a selected schedule item in response to the input of the confirmation key at step 620. The mobile communication terminal determines, at step 622, whether the selected schedule item has been executed in response to the user's selection. If a series of keys for returning to a higher-order menu such as the confirmation key, etc. is inputted at step 624, the mobile communication terminal displays the higher-order menu to the user, and then proceeds to step 608.

On the other hand, if the confirmation key is not inputted as a result of the determination at the above step 606, the mobile communication terminal determines, at the above step 608, whether a predetermined period of time has passed. If the predetermined period of time has passed, the mobile communication terminal determines, at step 610, whether another schedule exists. If another schedule exists, the mobile communication terminal displays another schedule. Otherwise, the procedure is terminated.

Alternatively, if another schedule does not exist as a result of the determination at the above step 610, the mobile communication terminal can be set to re-display the first schedule. In this case, the procedure can be terminated in response to inputs of a series of predetermined keys. Alternatively, the mobile communication terminal can adopt a schedule display screen as a background screen so that the user can readily identify the schedule.

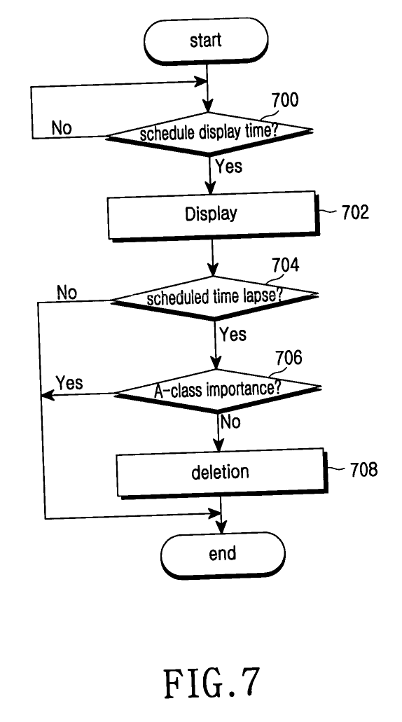

FIG. 7 is a flow chart illustrating a procedure of informing the user of a schedule in the mobile communication terminal at normal times in accordance with an embodiment of the present invention.

The mobile communication terminal usually displays contents of schedule items on a screen along with message alarms, which are provided at predetermined time intervals based on the level of importance of schedule items. When the number of schedule items to be displayed is more than one, the contents of the schedule items to be displayed are sequentially displayed according to their level of importance for several seconds until the confirmation key is stroked. If the user strokes the confirmation key, the user can view the schedule. Where some schedule item has already been executed or the user desires to delete some schedule item, the user designates the schedule item as an executed schedule item or a deletion item so that the schedule item is no longer displayed. If a start time of a daily schedule passes, other schedule items except for schedule items of A-class importance are deleted. The schedule items of A-class importance are stored for an entire management schedule until the user deletes them so that the user can remember events and tasks, which happened during that day.

The mobile communication terminal determines, at step 700 of FIG. 7, whether a present time matches an alarm time for schedule notification. The setting of the alarm time for schedule notification is the same as that described above. If the present time matches the alarm time for schedule notification, the mobile communication terminal displays the schedule on the display unit 120 at step 702. The mobile communication terminal determines, at step 704, whether a scheduled time of a schedule item has passed. If the scheduled time of the schedule item has passed, the mobile communication terminal determines, at step 706, whether the schedule item is of A-class importance. If the schedule item is not of A-class importance, the mobile communication terminal deletes the schedule item. That is, schedule items of lower-class importance are deleted after scheduled times, but only schedule items of A-class importance are continuously stored after scheduled times.

As apparent from the above description, the present invention can implement the following features.

According to the level of importance of schedule items, some schedule items stored in the mobile communication terminal can be automatically and selectively deleted after a predetermined duration, such as one day, after a start time of a schedule. Inputted schedule items can be arranged on the basis of importance so that a user can view all schedule items of the schedule at one time. A schedule screen can be set as a background screen. Through a schedule input screen, the user can directly decide the importance of the schedule items and input contents of the schedule items. On the basis of importance of the schedule items, different messages can be displayed. Where a plurality of schedule items are simultaneously displayed, they can be sequentially displayed at intervals of several seconds. The user can designate an executed schedule item using a specific key, and the executed schedule item can be automatically deleted after one day. Schedule items of A-class importance can be continuously stored in a screen for a list of previous schedule items so that the user can remember the most important previous events and tasks. Alternatively, the schedule items of A-class importance can be deleted, and may be deleted after a longer predetermined duration, such as one week, one month, etc.

On the other hand, after previous schedule items are deleted, they can be stored in a recoverable storage space. At this time, the mobile communication terminal can provide, to the user, a message asking whether the previous schedule items should be entirely deleted, at predetermined time intervals. Thus, the user can determine whether the previous schedule items should be deleted.

In accordance with the present invention, the mobile communication terminal can notify a user of schedule items of a daily schedule different numbers of times on a level of importance basis so that the user of the mobile communication terminal can remember the schedule.

Although the preferred embodiments of the present invention have been disclosed for illustrative purposes, those skilled in the art will appreciate that various modifications, additions and substitutions are possible, without departing from the scope of the invention. Accordingly, the present invention is not limited to the above-described embodiments, but the present invention is defined by the claims which follow, along with their full scope of equivalents.

1. A method for managing a schedule based on levels of importance in a mobile communication terminal, comprising the steps of:
a) determining whether a present time matches a start time of a schedule;
b) if the present time matches the start time of the schedule, determining whether schedule items of the schedule are set;
c) if the schedule items are set, displaying the schedule items according to the levels of importance; and
d) after a predetermined period of time has passed, displaying a next schedule according to the levels of importance.

2. The method as set forth in claim 1, further comprising the step of inputting, by a user, the schedule with a schedule start time, a time interval between notifications and a level of importance.

3. The method as set forth in claim 1, wherein step c) displays detailed contents of a selected schedule item when the mobile communication terminal receives a predetermined input from an input unit.

4. The method as set forth in claim 3, wherein the input unit of the mobile communication terminal includes at least one of a keypad, a stylus pen, a touch pad, and a jog dial.

5. The method as set forth in claim 1, wherein contents of the schedule displayed at step c) are set in a background screen of the mobile communication terminal.

6. A method for managing a schedule based on levels of importance in a mobile communication terminal, comprising the steps of:
a) determining whether a present time matches an alarm time for schedule notification;
b) if the present time matches the alarm time for schedule notification, displaying contents of the schedule;
c) determining whether a scheduled time of a schedule item contained in the schedule has passed;
d) if the scheduled time of the schedule item has passed, determining a level of importance of the schedule item; and
e) if the schedule item is of low level importance, deleting contents of the schedule item.

7. The method as set forth in claim 6, wherein the contents of the schedule item deleted at step e) are stored in a recoverable storage space of the mobile communication terminal.

8. The method as set forth in claim 7, wherein a message asking whether the contents of the schedule item stored in the recoverable storage space should be displayed is provided to a user.

9. The method as set forth in claim 8, wherein the contents of the schedule item stored in the recoverable storage space are deleted when deletion is selected in response to the message.
